(19) United States
(12) Patent Application Publication
(10) Pub. No.: US 2004/0153703 A1
(43) Pub. Date: Aug. 5, 2004

(54) Fault tolerant distributed computing applications

(75) Inventors: Charles Leslie Vigue, LaPine, OR (US); Daniel Joseph Melchione, Beaverton, OR (US); Ricky Y. Huang, Portland, OR (US)

Correspondence Address: KLARQUIST SPARKMAN, LLP, 121 SW SALMON STREET, SUITE 1600, PORTLAND, OR, 97204, US

(73) Assignee: Secure Resolutions, Inc.

(21) Appl. No.: 10/421,493

(22) Filed: Apr. 22, 2003

Related U.S. Application Data
(60) Provisional application No. 60/375,176, filed on Apr. 23, 2002.

(51) Int. Cl. H04L 1/22

(52) U.S. Cl. 714/4

(57) ABSTRACT

A technique for enhancing fault-tolerance of a distributed computing application, including applications provided via an application service provider (ASP) model, utilizes a separate monitoring program to monitor continued operation of the distributed application software (e.g., an ASP agent) on a node of the distributed application. The application software signals its continued operation by periodically generating a “heart beat” event. On failure of the application software on the node, the monitoring program takes action to restore the application on the node, such as by restarting the application, reinstalling the application software, logging failure and/or transmitting an alert to the application's administrator.

### PRIORITY CLAIM

This application claims the benefit of U.S. Provisional Patent Application No. 60/375,176, filed Apr. 23, 2002, which is hereby incorporated herein by reference.

### TECHNICAL FIELD

The invention relates to software applications using distributed computing or processing (such as those based on an application service provider (ASP) model) and, more particularly, to fault-tolerance techniques applicable to such distributed applications.

### CROSS-REFERENCE TO OTHER APPLICATIONS

The U.S. provisional patent applications No. 60/375,215, Melchione et al., entitled, “Software Distribution via Stages”; No. 60/375,216, Huang et al., entitled, “Software Administration in an Application Service Provider Scenario via Configuration Directives”; No. 60/375,174, Melchione et al., entitled, “Providing Access To Software Over a Network via Keys”; No. 60/375,154, Melchione et al., entitled, “Distributed Server Software Distribution,”; and No. 60/375,210, Melchione et al., entitled, “Executing Software In A Network Environment”; all filed Apr. 23, 2002, are hereby incorporated herein by reference.

### BACKGROUND

Distributed computing and distributed processing refer generally to applications where the processing workload for the application is distributed over disparate computers (also referred to as “nodes”) that are linked through a data communications network.

One representative example is applications based on an application service provider (ASP) model. The ASP model has recently gained much popularity as a way for business enterprises to outsource responsibility for managing business applications (e.g., email, human resource management, payroll, customer relation management, project management, accounting, etc.) to outside providers (termed the “application service provider”). The ASP typically delivers the application software by centrally hosting a portion of the application on a server computer (e.g., as a network-based service). Another portion of the application can be carried out on the users' computers that access the host server over a data communications network. (The portions of the application performed by the hosting server versus the user computer can vary along a spectrum from only administrative functions like configuration and installation being performed at the hosting server to the user computer performing only user interface operations of the application.) The ASP model allows the ASP provider to more effectively administer the applications as compared to administering separate, stand-alone installations of the application on each user's computer. In large enterprises whose computers are spread among various business locations and departments, the ASP model can provide significant savings in administrative costs.

In ASP and other distributed computing applications, the portion of the application software that runs on users' computers can fail for a variety of reasons, including hardware/software incompatibilities, system errors (such as a general protection fault), and application bugs. Additionally, execution of the application software on the users' computers can be halted through intentional or unknowing user intervention (e.g., choosing to terminate the application process on the user's computer, or re-configuring the computer to not run the application software). Because these failures occur on the users' machines, they are generally outside of the knowledge and control of the ASP provider or any network administrator for the enterprise.

These failures can cause significant problems, both to achieving application objectives and to effectively providing technical support for the application. For an ASP-based anti-virus application, as a particular example, it can be critical to have the anti-virus application running at all times on all user computers in order to more effectively prevent computer virus outbreaks in the organization. Further, in large enterprises, it can be a very expensive proposition to have professional network administrators or support technicians personally administer the application on each user computer. On the other hand, the users themselves may lack the knowledge and/or willingness to correctly administer the application on their own computers. Further, where the anti-virus application is designed to run “in the background” while the user performs other computing tasks, it may not be apparent to the user that the application is no longer running. Accordingly, failures can prevent the ASP-based anti-virus application from running on users' computers, potentially exposing the enterprise to security threats. With the failure occurring on a user's computer, the ASP provider or network administrator also remain unaware of the failure, and therefore unable to address the problem. Similarly, failures at distributed nodes of other distributed computing applications pose administrative issues (e.g., loss of the ASP or other administrator's ability to further update or configure the application on the node) and obstacles to achieving application objectives (e.g., application operations no longer being performed at the node).

### SUMMARY

In implementations of fault-tolerant distributed computing applications described herein, a separate monitoring program is installed and configured to run along with the local program portion of the application on the application's various distributed nodes. The monitoring program operates as a kind of “watchdog” to monitor continuing execution of the application's local program on that node, and take appropriate action to restore the application's local program to proper execution in the event of failure (such as by automatically restarting, reinstalling, and/or reporting failure to a human administrator for corrective action).

In one illustrative fault-tolerant distributed computing application implementation, the application's local program signals its continued operation on a recurrent basis (e.g., as a periodic “heart beat” signal, which can have the form of a named event, or other form of inter-program communication). The monitoring program, in turn, “listens” for this signal to detect failure of the application's local program. If no “heart beat” signal is detected within a threshold interval, the monitoring program determines that the application's local program has failed, and initiates restorative action(s).

In the illustrative implementation, the restorative action includes first attempting to restart the application's local program one or more times. If the monitoring program still fails to detect operation of the application's local program, the monitoring program next attempts to reinstall and then restart the application's local program. The monitoring program first reinstalls a currently updated version of the application's program, such as by downloading from a network location. If failure continues, the monitoring program then reinstalls a “last known good” version of the application's local program that was previously known to operate successfully on the node, which may be a locally archived version or alternatively downloaded from a network location. If the application's local program still fails, the monitoring program may reinstall or restart the application's local program in a reduced functionality mode. Additionally, the monitoring program reports the failure to a human administrator to permit corrective human intervention, such as by logging and/or transmitting notification of the failure. In other implementations, the monitoring program can take fewer or additional actions attempting to restore operation of the application's local program.

In the illustrative implementation, the monitoring program has multiple restart modes, such as an initial rapid restart mode in which restarts are attempted at shorter intervals and a second slower restart mode at longer intervals. Alternatively, each restart attempt can be at successively longer delay intervals from a last attempt. The slower restart mode is intended to addresses failures that occur during temporary computing resource shortages (e.g., low available memory conditions) on the node. The longer intervals between restarts may permit the resource shortage to be alleviated more quickly, so that a next restart attempt with the resource shortage hopefully alleviated may result in restored operation of the application's local program.

The monitoring program preferably is designed to be highly reliable, such as by isolating the monitoring program from the application's local program in a separate process and/or protection ring of the processor, and by not utilizing code or libraries shared with any other program. The monitoring program's reliability can be further enhanced by keeping its design simple, and infrequently if ever changing its code.

Additional features and advantages will be made apparent from the following detailed description of illustrated embodiments, which proceeds with reference to the accompanying drawings.

### BRIEF DESCRIPTION OF THE DRAWINGS

FIG. 1 is an illustration of an exemplary application service provider model.

FIG. 2 is an illustration of an exemplary arrangement for administration of fault-tolerant distributed computing applications based on the application service provider model of FIG. 1.

FIG. 3 depicts an exemplary user interface for administration of the application service provider-based, fault-tolerant distributed computing application of FIG. 2.

FIG. 4 illustrates an exemplary business relationship accompanying the application service provider model of FIG. 1.

FIG. 5 shows an example anti-virus application based on and administered via the application service provider model illustrated in FIGS. 1 and 2.

FIG. 6 is a flow diagram of a process for enhancing fault tolerance of the application service provider-based, fault-tolerant distributed computing application of FIG. 2.

### DETAILED DESCRIPTION

### Application Service Provider Overview

In one illustrative implementation, fault-tolerance techniques described herein including the “watchdog” monitoring program for enhanced fault tolerance in distributed computing is incorporated into a distributed computing application based on the application service provider (ASP) model. In other alternative implementations, non-ASP-based distributed computing or distributed processing applications also can incorporate the “watchdog” monitoring program and other techniques and methods described herein to enhance their fault-tolerance.

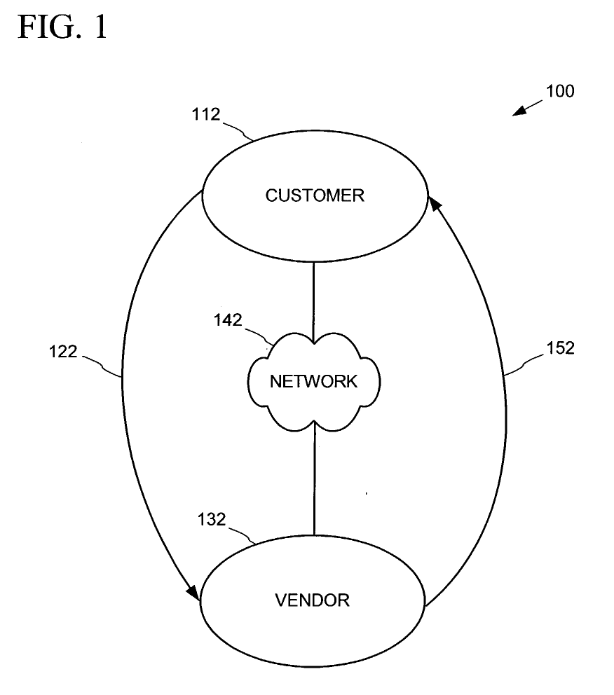

An exemplary application service provider scenario 100 is shown in FIG. 1. In the scenario 100, a customer 112 sends requests 122 for application services to an application service provider vendor 132 via a network 142. In response, the vendor 132 provides application services 152 via the network 142. The application services 152 can take many forms for accomplishing computing tasks related to a software application or other software.

To accomplish the arrangement shown, a variety of approaches can be implemented. For example, the application services can include delivery of graphical user interface elements (e.g., hyperlinks, graphical checkboxes, graphical pushbuttons, and graphical form fields) which can be manipulated by a pointing device such as a mouse. Other application services can take other forms, such as sending directives or other communications to devices of the vendor 132.

To accomplish delivery of the application services 152, a customer 112 can use client software such as a web browser to access a data center associated with the vendor 132 via a web protocol such as an HTTP-based protocol (e.g., HTTP or HTTPS). Requests for services can be accomplished by activating user interface elements (e.g., those acquired by an application service or otherwise) or automatically (e.g., periodically or as otherwise scheduled) by software. In such an arrangement, a variety of networks (e.g., the Internet) can be used to deliver the application services (e.g., web pages conforming to HTML or some extension thereof) 152 in response to the requests. One or more clients can be executed on one or more devices having access to the network 142. In some cases, the requests 122 and services 152 can take different forms, including communication to software other than a web browser.

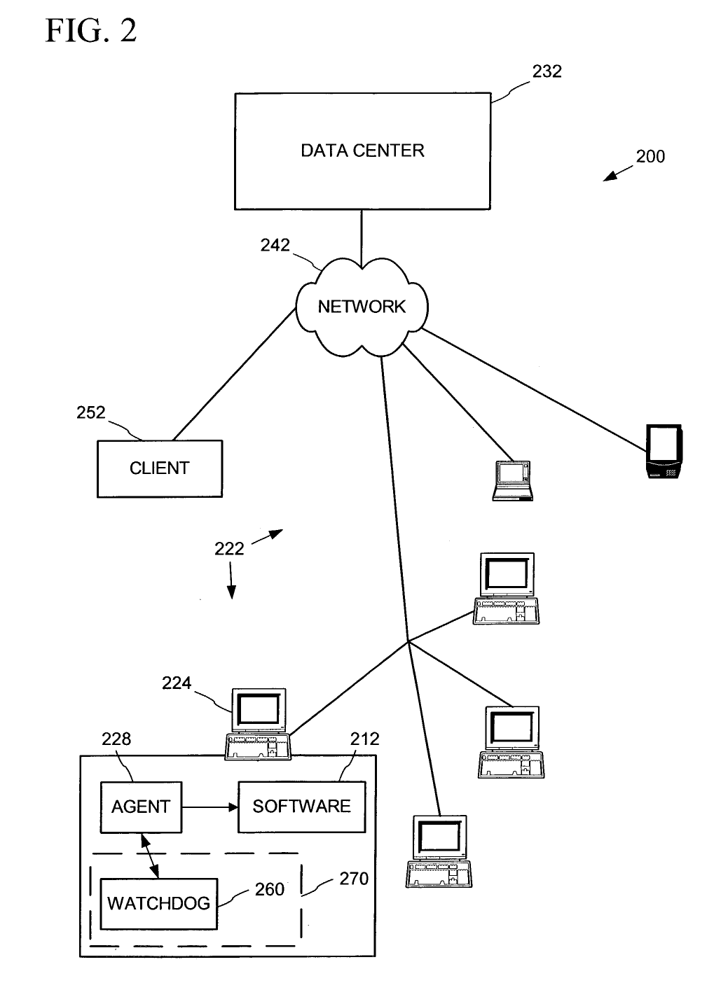

The fault tolerance technologies described herein can be used for software (e.g., one or more applications) across a set of devices administered via an application services provider scenario. The administration of software can include software installation, software configuration, software management, or some combination thereof. FIG. 2 shows an exemplary arrangement 200 whereby an application service provider provides services for administering software (e.g., administered software 212) across a set of administered devices 222. The administered devices 222 are sometimes called “nodes.”

In the arrangement 200, the application service provider provides services for administrating instances of the software 212 via a data center 232. The data center 232 can be an array of hardware at one location or distributed over a variety of locations remote to the customer. Such hardware can include routers, web servers, database servers, mass storage, and other technologies appropriate for providing application services via the network 242. Alternatively, the data center 232 can be located at a customer's site or sites. In some arrangements, the data center 232 can be operated by the customer itself (e.g., by an information technology department of an organization).

The customer can make use of one or more client machines 252 to access the data center 232 via an application service provider scenario. For example, the client machine 252 can execute a web browser, such as Microsoft Internet Explorer, which is marketed by Microsoft Corporation of Redmond, Wash. In some cases, the client machine 252 may also be an administered device 222.

The administered devices 222 can include any of a wide variety of hardware devices, including desktop computers, server computers, notebook computers, handheld devices, programmable peripherals, and mobile telecommunication devices (e.g., mobile telephones). For example, a computer 224 may be a desktop computer running an instance of the administered software 212.

The computer 224 may also include an agent 228 for communicating with the data center 232 to assist in administration of the administered software 212. In an application service provider scenario, the agent 228 can communicate via any number of protocols, including HTTP-based protocols.

The administered devices 222 can run a variety of operating systems, such as the Microsoft Windows family of operating systems marketed by Microsoft Corporation; the Mac OS family of operating systems marketed by Apple Computer Incorporated of Cupertino, Calif.; and others. Various versions of the operating systems can be scattered throughout the devices 222.

The administered software 212 can include one or more applications or other software having any of a variety of business, personal, or entertainment functionality. For example, one or more anti-virus, banking, tax return preparation, farming, travel, database, searching, multimedia, security (e.g., firewall) and educational applications can be administered. Although the example shows that an application can be managed over many nodes, the application can appear on one or more nodes.

In the example, the administered software 212 includes functionality that resides locally to the computer 224. For example, various software components, files, and other items can be acquired by any of a number of methods and reside in a computer-readable medium (e.g., memory, disk, or other computer-readable medium) local to the computer 224. The administered software 212 can include instructions executable by a computer and other supporting information. Various versions of the administered software 212 can appear on the different devices 222, and some of the devices 222 may be configured to not include the software 212.

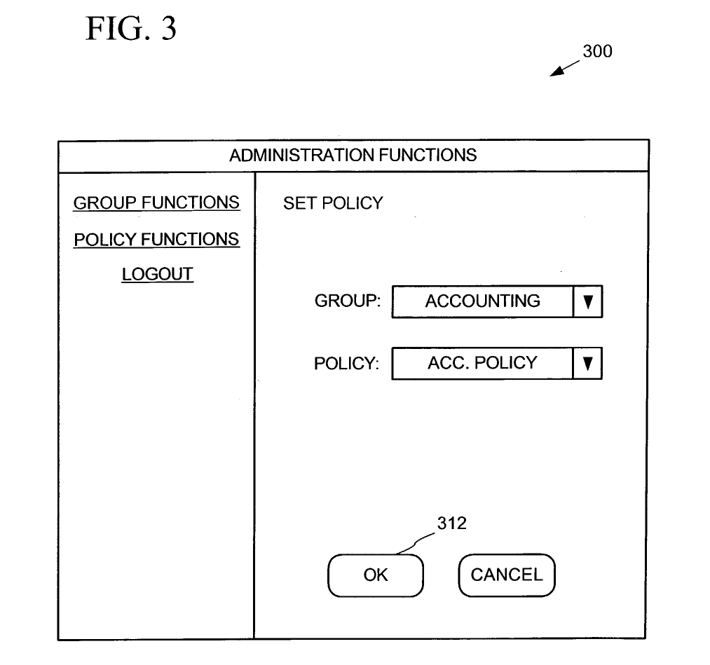

FIG. 3 shows an exemplary user interface 300 presented at the client machine 252 by which an administrator can administer software for the devices 222 via an application service provider scenario. In the example, one or more directives can be bundled into a set of directives called a “policy.” In the example, an administrator is presented with an interface by which a policy can be applied to a group of devices (e.g., a selected subset of the devices 222). In this way, the administrator can control various administration functions (e.g., installation, configuration, and management of the administered software 212) for the devices 222. In the example, the illustrated user interface 300 is presented in a web browser via an Internet connection to a data center (e.g., as shown in FIG. 2) via an HTTP-based protocol.

Activation of a graphical user interface element (e.g., element 312) can cause a request for application services to be sent. For example, application of a policy to a group of devices may result in automated installation, configuration, or management of indicated software for the devices in the group.

In the examples, the data center 232 can be operated by an entity other than the application service provider vendor. For example, the customer may deal directly with the vendor to handle setup and billing for the application services. However, the data center 232 can be managed by another party, such as an entity with technical expertise in application service provider technology.

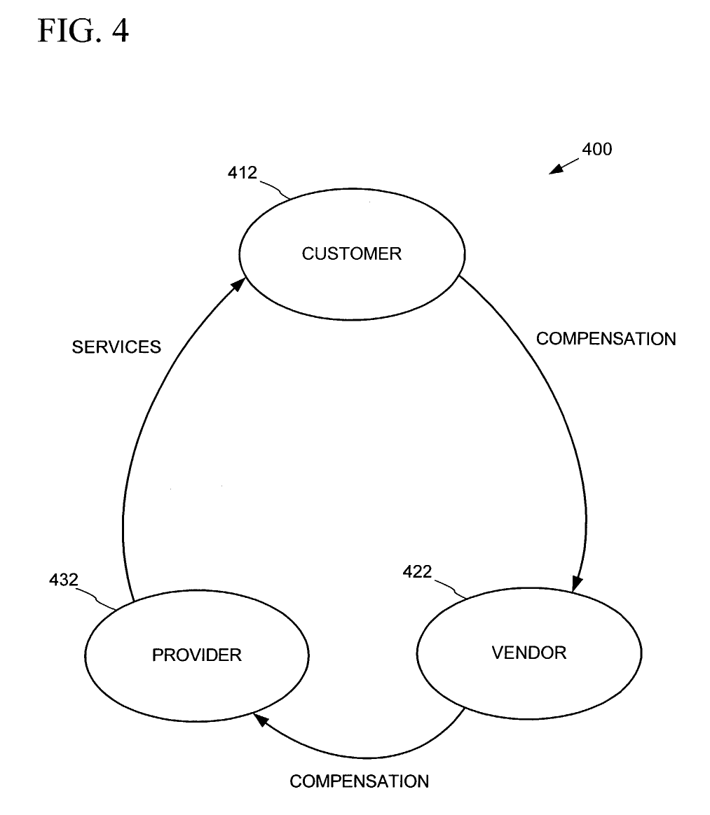

The scenario 100 (FIG. 1) can be accompanied by a business relationship between the customer 112 and the vendor 132. An exemplary relationship 400 between the various entities is shown in FIG. 4. In the example, a customer 412 provides compensation to an application services provider vendor 422. Compensation can take many forms (e.g., a monthly subscription, compensation based on utilized bandwidth, compensation based on number of uses, or some other arrangement (e.g., via contract)). The provider of application services 432 manages the technical details related to providing application services to the customer 412 and is said to “host” the application services. In return, the provider 432 is compensated by the vendor 422.

The relationship 400 can grow out of a variety of situations. For example, it may be that the vendor 422 has a relationship with or is itself a software development entity with a collection of application software desired by the customer 412. The provider 432 can have a relationship with an entity (or itself be an entity) with technical expertise for incorporating the application software into an infrastructure by which the application software can be administered via an application services provider scenario such as that shown in FIG. 2.

Although not shown, other parties may participate in the relationship 400. For example, network connectivity may be provided by another party such as an Internet service provider. In some cases, the vendor 422 and the provider 432 may be the same entity. It is also possible that the customer 412 and the provider 432 be the same entity (e.g., the provider 432 may be the information technology department of a corporate customer 412).

Although administration can be accomplished via an application service provider scenario as illustrated, functionality of the software being administered need not be so provided. For example, a hybrid situation may exist where administration and distribution of the software is performed via an application service provider scenario, but components of the software being administered reside locally at the nodes.

### EXAMPLE

### ASP-Based Anti-Virus Software Application

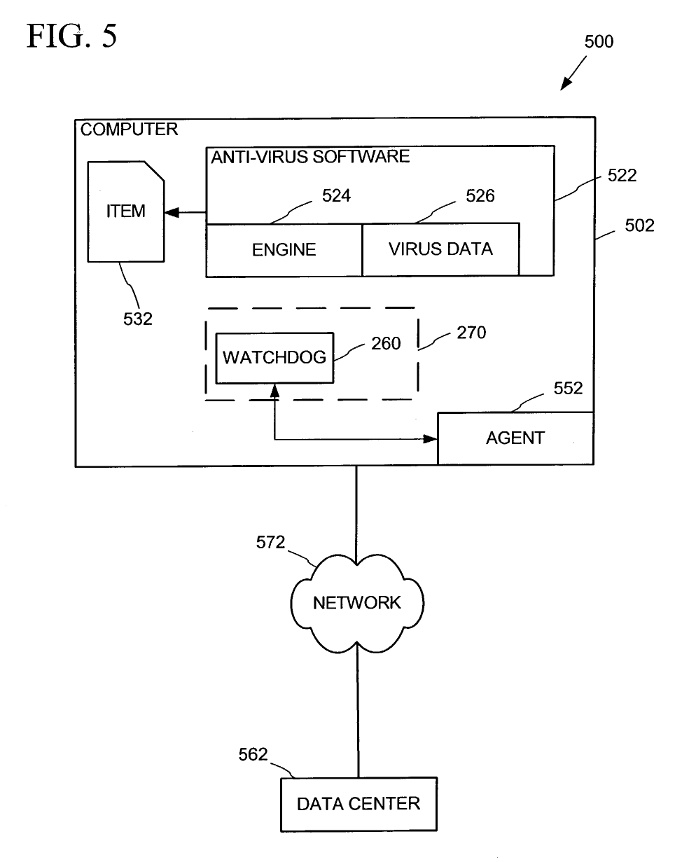

As an illustrative example, the software being administered in the ASP scenario 100 can be anti-virus software. An exemplary anti-virus software arrangement 500 is shown in FIG. 5.

In the arrangement 500, a computer 502 (e.g., a node) is running the anti-virus software 522. The anti-virus software 522 may include a scanning engine 524 and the virus data 526. The scanning engine 524 is operable to scan a variety of items (e.g., the item 532) and makes use of the virus data 526, which can contain virus signatures (e.g., data indicating a distinctive characteristic showing an item contains a virus). The virus data 526 can be provided in the form of a file.

A variety of items can be checked for viruses (e.g., files on a file system, email attachments, files in web pages, scripts, etc.). Checking can be done upon access of an item or by periodic scans or on demand by a user or administrator (or both).

In the example, agent software 552 communicates with a data center 562 (e.g., operated by an application service provider) via a network 572 (e.g., the Internet). Communication can be accomplished via an HTTP-based protocol. For example, the agent 552 can send queries for updates to the virus data 526 or other portions of the anti-virus software 522 (e.g., the engine 524).

### Watchdog Monitoring Program

In accordance with fault-tolerance enhancing techniques described herein, the illustrated ASP arrangement 200 of FIG. 2 (which may be the exemplary ASP-based anti-virus application 500 of FIG. 5) also incorporates a monitoring program 260 (also referred to as the “watchdog program”) at its nodes 222 (e.g., at administered device or computer 224). The monitoring program 260 monitors the continuing operation of the ASP-based application, and in the event of failure, takes action to restore the ASP-based application to operating condition. In this way, the ASP-based application can be returned to its operating state despite failures where execution of the application software on the node has been terminated or even where the application software has been rendered unexecutable on the node (e.g., due to a hardware/software incompatibility, application bug, or corruption of the application software). Further, the fault-tolerance techniques act to avoid silent failures which could remain unnoticed by the application user, ASP provider or other application administration personnel.

The monitoring program 260 preferably is designed to be highly reliable, such that the monitoring program 260 is likely to remain in operation although other software of the ASP arrangement 200 running on the node 224 has failed. Measures to enhance the reliability of the monitoring program 260 can include running the monitoring program 260 as a separate process 270 under a multi-processing operating system on the node 224, and/or running the monitoring program 260 at a protection ring or mode of the node's processor protection scheme above that of other application software (e.g., in protected mode or kernel mode). Further, the monitoring program can be programmed using certain software design principals aimed at enhancing its reliability. For example, the design of the monitoring programming 260 preferably is kept simple and unchanging although development, enhancement and upgrades of other of the ASP arrangement software continues. To achieve this design principle, the monitoring program 260 can be designed to include a core part of the functionality for monitoring and restoring the ASP-based application, while other parts of fault-tolerance technique's functionality that may require further update or enhancement is provided by other of the ASP arrangement's software, such as in the agent 228 or part thereof. As a particular example, the code for logging and transmitting notification of failure to the ASP provider or other administrator can be programmed into a reduced functionality subset of the agent 228 software, which the monitoring program restarts and uses during restoration of the ASP arrangement as discussed more fully below. Such design permits the logging and transmitting code to be further enhanced without any further alteration of the monitoring program 260. The code of the monitoring program 260 can then be finalized early in the design of the ASP arrangement 200. This avoids the possibility that further alteration of the monitoring program could introduce software bugs. In still other alternative implementations, the operations of the monitoring program can instead by implemented as hardware, such as in the circuitry of the “chip set” of the administered device 224.

The monitoring program 260 preferably also is set up to run on the node whenever the ASP arrangement is to be in operation on the node. In some applications (e.g., the ASP-based anti-virus application described above), the ASP arrangement is to be in operation as all times that the node is “on.” In such case, the monitoring program can be set up to be started as part of the node's start-up routine at power on or boot-up. In other applications, the monitoring program can be started when the application is started on the node, or when the agent is started on the node.

For monitoring the ASP arrangement's continued operation, one or more portions of software of the ASP arrangement 100 that runs locally on the node recurrently signals its continued operation (e.g., as a periodic “heart beat” signal) to the monitoring program 260. In the illustrated ASP arrangement 100, the agent program 228 generates this heart-beat signal. In alternative implementations, other local programs of the distributed computing application on the node can send the heart-beat signal, such as the software 212 administered by the agent (e.g., the anti-virus software program 522 of FIG. 5). In the illustrated ASP arrangement 100, the signal is sent as a named event using an eventing API (application programming interface) of the operating system at about half second intervals (e.g., based on the node's real-time clock or like). Alternatively, other forms of inter-program communication can be used, such as inter-process procedure calls, and interrupts, among others. Further, in other implementations, the heart-beat signal can be generated more or less frequently.

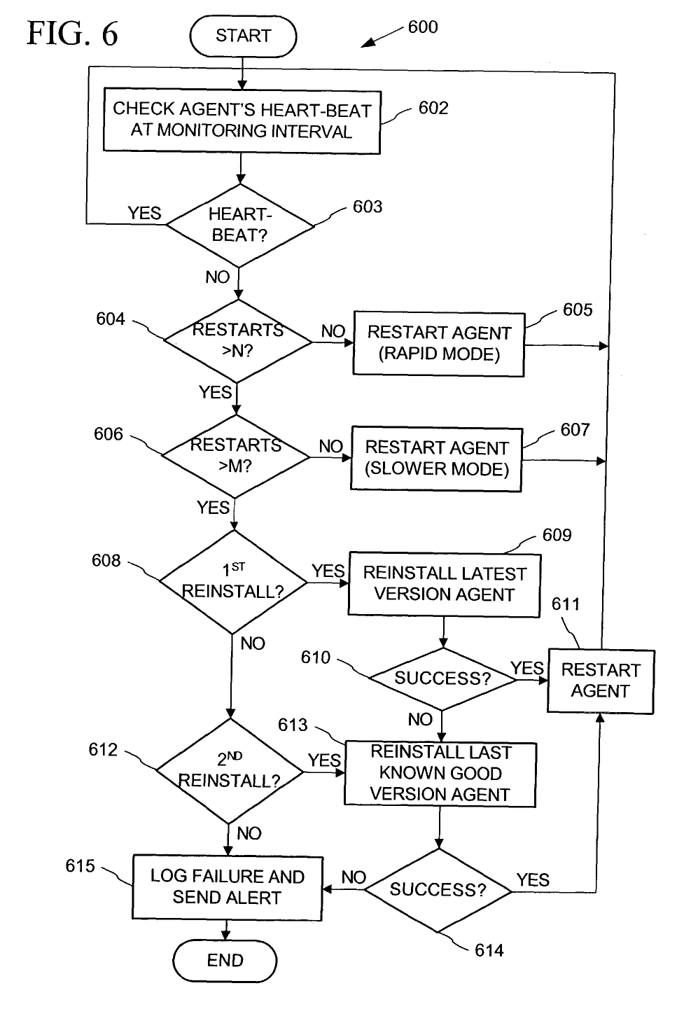

FIG. 6 illustrates the operation 600 of the monitoring program 260. At actions 602-603, the monitoring program 260 monitors the heart-beat signal to detect failure of the ASP arrangement 200 at the node 224. The monitoring program 260 detects that the ASP arrangement 200 has failed when the heart-beat signal ceases to be generated. As indicated more particularly at action 602, the monitoring program 260 checks at monitoring intervals (e.g., 2 seconds or like other interval longer than the heart-beat interval) whether a new heart-beat signal has been generated. If no heart-beat signal was generated in the monitoring interval, the monitoring program 260 determines at action 603 that the agent has failed.

In some alternative implementations, the monitoring program 260 can detect failure of the monitoring program 260 on other bases than a recurrent heart-beat signal. For example, the monitoring program can query the execution status of the agent from the task manager of the node's operating system, which could determine whether the agent is still listed as a running program or process or has been aborted. However, detection based on the agent generating a recurrent signal is preferred because such detection verifies that the agent remains active (whereas in some failure conditions the agent may still be reported by the operating system as a running program although its execution has merely stalled, and has not been aborted).

Upon detecting failure, the monitoring program 260 proceeds to initiate corrective action(s) to restore proper operation of the ASP arrangement 200. Initially as indicated at actions 604-605, the monitoring program 260 immediately attempts to restart the agent 228 in a rapid restart mode, such as by issuing an execute command to the operating system of the node 224. The monitoring program 260 then returns to monitoring for a heart-beat signal from the agent at actions 602-603. The monitoring program 260 tracks the number of restart attempts it makes, and repeats attempts at restarting the agent in the rapid mode several times (e.g., N times as indicated at action 604).

On further failure(s) after the rapid restart mode attempts (in actions 604-605), the monitoring program 260 further attempts to restart the agent in a slower mode indicated at actions 606-607. In some circumstances, the failure of the agent at the node can be due to low computing resource availability (e.g., low available memory condition or like). In such case, the attempts to restart the agent may not succeed until the low resource condition has been alleviated (e.g., upon completion or termination of another program's high resource usage task). Further, overly rapid restart attempts by the monitoring program could exacerbate the low resource condition, preventing or delaying completion of other high resource usage tasks. For the slow restart mode, the monitoring program 260 temporarily increases the length of the monitoring interval (e.g., until the agent is restored and generating heart-beat signals) so that restart attempts at action 607 occur after longer delays than in the rapid restart mode (e.g., 5 or 10 seconds or longer intervals). The monitoring program 260 also repeats attempts to restart the agent in the slower mode several times (e.g., M-N times as indicated at action 606). For example, the monitoring program 260 in some implementations can attempt up to 5 restarts in the rapid mode, followed by up to 5 restarts in the slower mode, although fewer or more attempts can be made in alternative implementations. After each restart attempt, the monitoring program 260 returns to monitoring for a heart-beat signal from the agent at actions 602-603.

If the restart attempts still fail to restore operation of the agent, the monitoring program 280 attempts to reinstall the agent software on the node in actions 608-611. A possible cause of the failure may be due to corruption of the installed version of the agent software, in which case reinstalling the agent software on the node may cure the failure. In a first reinstallation attempt, the monitoring program reinstalls a latest version (e.g., most recent update version) of the agent. Preferably, the monitoring program obtains the latest version anew from the ASP provider 432 (FIG. 4), such as by download from the data center 232 or other server accessible via the network 242. Alternatively, the monitoring program can reinstall the latest version of the agent software from a locally archived copy stored at the node 224. If the reinstallation succeeds at action 610, the monitoring program restarts the just reinstalled agent software at action 611 and returns to monitoring for the agent's heart-beat signal at action 602-603.

If the agent still fails at action 612 (or alternatively the first reinstallation fails at 610), the monitoring program performs a second reinstallation of the agent software. Another possible cause of the failure may be due to an upgrade of the agent software that introduced a hardware or software incompatibility at the node, in which case reinstalling a prior version of the agent software that is known to run well on the node (called a “last known good version”) may cure the failure. In the second reinstallation at action 613, the monitoring program reinstalls this last known good version of the agent software on the node. For purposes of identifying a last known good version of the agent software, the agent 228 can record its version number as being the “last known good version” of the agent software for the node each time the agent is run successfully to completion (e.g., as part of the agent's shut-down procedure or like point in the execution of the agent that is indicative of successful operation). The agent 228 can record the last known good version information into a configuration file stored on the node, or alternatively report same to the ASP provider's data center or other suitable location where the information can be retrieved by the monitoring program at action 613. The monitoring program can obtain the software of the last known good version by download from the ASP provider's data center or other server, or from an archived copy stored at the node. If the reinstallation succeeds at action 614, the monitoring program restarts the just reinstalled agent software at action 611 and returns to monitoring for the agent's heart-beat signal at action 602-603.

If the rapid/slow restarts and reinstalls all fail to restore the agent, the monitoring program finally takes action 615 to notify a human administrator of the failure, so as to avoid silent failure of the ASP application on the node and allow the administrator to take appropriate manual intervention to restore operation of the agent. In one implementation, the monitoring program uploads information reporting the failure to the ASP provider's data center, where the information can be made available to an administrator for the ASP application. The failure information can be made available to the administrator in an administrative utility program or console for the ASP application. Additionally or alternatively, the failure information can be sent in a message to the administrator in email, instant message, pager, voice mail, or the like. The monitoring program also locally logs information about the failure to a file stored on the node. In some implementations, a message can be displayed (e.g., in an error dialog box or like) to the user on the node informing the user of the failure and advising to contact the ASP application's administrator or other technical support administrator.

For improved reliability of the monitoring program (as discussed above), the monitoring program preferably incorporates only core functionality for its operation 600, so as to avoid later need to update the monitoring program. As one example, the code to upload information to the data center (which is used by the monitoring program to report the failure to an administrator at action 615) can be located in a separate program on the node, such as even in the agent itself (more specifically, a reduced functionality subset of the agent software). At action 615, the monitoring program then restarts the agent in a reduced functionality mode in which the upload code is operative but much of the functionality of the agent is otherwise disabled to avoid further failures. The monitoring program then initiates upload of the failure information to the data center 232 by the reduced functionality mode agent.

Although the monitoring program 260 is described in the foregoing discussion of its operation 600 as monitoring and restoring operation of the agent 228, the monitoring program can alternatively monitor and restore operation of the application software 212 on the node. Further, alternative implementations of the monitoring software can include fewer or additional actions to restore operation of the agent 228, application software 212 or other monitored software on the node in the event of their failure.

### Alternatives

Having described and illustrated the principles of our invention with reference to illustrated embodiments, it will be recognized that the illustrated embodiments can be modified in arrangement and detail without departing from such principles. It should be understood that the programs, processes, or methods described herein need not be related or limited to any particular type of computer apparatus. Various types of general purpose or specialized computer apparatus may be used with, or perform operations in accordance with, the teachings described herein. Elements of the illustrated embodiment shown in software may be implemented in hardware and vice versa.

Technologies from the preceding examples can be combined in various permutations as desired. Although some examples describe an application service provider scenario, the technologies can be directed to other distributed computing or distributed processing applications. Similarly, although some examples describe anti-virus software, the technologies can be directed to other applications.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

We claim:

1. A computer-implemented method of enhancing fault-tolerance of a distributed computing application, the method comprising:
running a monitoring program on a node in a network in connection with running software of the distributed computing application on the node;
in the monitoring program, recurrently checking continued operation of the distributed computing application's software on the node; and
in the event of failure, initiating by the monitoring program an action to restore the distributed computing application.

2. The method of claim 1 wherein the distributed computing application includes an administrative agent for an application service provider.

3. The method of claim 1 further comprising:
in the distributed computing application running on the node, recurrently signaling its continued operation; and
in the monitoring program, monitoring for receipt of the distributed computing application's signaling within a monitoring interval to check the distributed computing application's continued operation on the node.

4. The method of claim 1 wherein the action to restore the distributed computing application comprises restarting the distributed computing application on the node.

5. The method of claim 1 wherein the action to restore the distributed computing application comprises iteratively attempting to restart the distributed computing application on the node at increasingly longer intervals.

6. The method of claim 1 wherein the action to restore the distributed computing application comprises, while the distributed computing application remains inoperative, attempting to restart the distributed computing application one or more times in a plurality of restart modes, at least one of the restart modes having a longer interval between restart attempts than in another of the restart modes.

7. The method of claim 1 wherein the action to restore the distributed computing application comprises reinstalling the software for the distributed computing application on the node.

8. The method of claim 1 wherein the action to restore the distributed computing application comprises reinstalling a latest update version of the software for the distributed computing application on the node.

9. The method of claim 1 wherein the action to restore the distributed computing application comprises reinstalling a version of the software for the distributed computing application on the node that was previously known to run without failure on the node.

10. The method of claim 1 wherein the action to restore the distributed computing application comprises logging information of the failure.

11. The method of claim 1 wherein the action to restore the distributed computing application comprises transmitting information of the failure to an administrative server or data center for the distributed computing application.

12. The method of claim 1 wherein the action to restore the distributed computing application comprises sending an alert to a human administrator of the distributed computing application.

13. A computer-implemented method of enhancing fault-tolerance of an application provided at nodes of a distributed network via an application service provider model, the method comprising:
periodically during execution of an application service provider agent program on a node, generating an event signaling continued operation of said agent program on the node;
at periodic intervals, checking that the event was generated during a current interval;
if the event was not generated in the interval, restoring the application service provider agent to operation by:
at least once restarting the application service provider agent;
if restarting does not restore the application service provider agent, reinstalling software of the application service provider agent on the node and restarting the application service provider agent;
if reinstalling the application service provider agent does not restore the application service provider agent, transmitting notification of the application service provider agent's failure on the node to a data center for the application service provider.

14. A fault-tolerant application service providing system of distributed computing nodes communicating via a data network, comprising:
an application service providing data center;
a computing node interconnected via the data network with the application service providing data center;
on the computing node, an application service providing agent for providing an application on the computing node administered via the application service providing data center;
a monitor program on the computing node for monitoring continued operation of the application service providing agent, and operating upon detecting failure of the application service providing agent to initiate a restorative action to restore the application service providing agent to operation on the node.

15. The fault-tolerant application service providing system of claim 14 wherein the monitor program further operates to report failure of the application service providing agent on the node to the application service providing data center.

16. The fault-tolerant application service providing system of claim 14 wherein the monitor program further operates to report failure of the application service providing agent on the node to the application service providing data center when the restorative action fails to restore the application service providing agent to operation on the node.

17. The fault-tolerant application service providing system of claim 14 wherein the restorative action comprises restarting the application service providing agent on the node.

18. The fault-tolerant application service providing system of claim 14 wherein the restorative action comprises initiating restarts of the application service providing agent on the node, initially at shorter restart intervals and later at longer intervals, thereby permitting a temporary low resource availability condition to be alleviated.

19. The fault-tolerant application service providing system of claim 14 wherein the restorative action comprises obtaining from the application service providing data center and reinstalling a current version of the application service providing agent on the node.

20. The fault-tolerant application service providing system of claim 14 wherein the restorative action comprises reinstalling a version of the application service providing agent on the node that is recorded to have most recently successfully operated on the node.

21. The fault-tolerant application service providing system of claim 14 wherein the restorative action comprises logging failure of the application service providing agent on the node.

22. The fault-tolerant application service providing system of claim 14 wherein the restorative action comprises uploading information of the failure to the application service providing data center.

23. A computer-readable media for carrying a fault-tolerance enhancing program for a distributed computing application, the program comprising for execution at a computing node on a data network:
means for monitoring continued operation of the distributed computing application at the computing node to detect failure of the distributed computing application to continually operate on the computing node;
means responsive to the failure being detected, for initiating actions to restore the distributed computing application to operation on the computing node; and
means responsive to failure to restore operation of the distributed computing application on the computing node, for transmitting information of the failure to a distributed computing application administering server on the data network.
